(19) United States
(12) Patent Application Publication
(10) Pub. No.: US 2019/0147275 A1
(43) Pub. Date: May 16, 2019

(54) DRIVER MONITORING APPARATUS, METHOD, AND RECORDING MEDIUM

(71) Applicants: OMRON Corporation, Kyoto-shi (JP); OMRON Automotive Electronics Co. Ltd., Komaki-shi (JP)

(72) Inventors: Yoshio MATSUURA, Kasugai-shi (JP); Masato TANAKA, Kizugawa-shi (JP); Keisuke YOKOTA, Kasugai-shi (JP)

(73) Assignees: OMRON Corporation, Kyoto-shi (JP); OMRON Automotive Electronics Co. Ltd., Komaki-shi (JP)

(21) Appl. No.: 16/183,730

(22) Filed: Nov. 8, 2018

(30) Foreign Application Priority Data
Nov. 15, 2017 (JP) 2017-219897
Nov. 5, 2018 (JP) 2018-208452

(51) Int. Cl. G06K 9/00; G08G 1/052

(52) U.S. Cl. CPC G06K 9/00845; G08G 1/052

(57) ABSTRACT

To enable monitoring of both the direction and the level of attention being paid by a vehicle driver, a driver monitoring apparatus uses a detector to detect the attention direction of the driver based on monitoring data output from a first sensor, uses a calculator to repeatedly calculate, at every deviation calculation time, a deviation (e.g., standard deviation) of the attention direction during a deviation calculation duration, and uses a determiner to determine the direction and the level of attention being paid by the driver based on the calculated deviation.

### CROSS-REFERENCE TO RELATED APPLICATION

This application claims priority to Japanese Patent Application No. 2017-219897 filed on Nov. 15, 2017 and Japanese Patent Application No. 2018-208452 filed on Nov. 5, 2018, the entire disclosures of which are incorporated herein by reference.

### FIELD

Embodiments of the present invention relate to a driver monitoring apparatus that monitors, for example, a vehicle driver, a method for such monitoring, and a recording medium having a program for such monitoring recorded thereon.

### BACKGROUND

Nowadays, vehicles such as automobiles incorporate various apparatuses that assist the driver while the vehicle is traveling. One known example is a distracted driving determination apparatus that determines whether the driver is engaging in inappropriate driving such as distracted driving. The apparatus generates an alert to the driver engaging in distracted driving. The distracted driving determination apparatus determines whether the driver is engaging in distracted driving by detecting the face or gaze direction of the driver and determining the position at which the driver is looking.

However, the face or gaze direction of the driver alone may be insufficient to accurately determine distracted driving.

For example, Patent Literature 1 describes distracted driving determination using the gaze focus of a driver and the measured duration for which the gaze focus is in a specific direction. More specifically, the technique described in Patent Literature 1 uses time in addition to the face or gaze direction of the driver to enable the monitoring of the direction and the level of attention being paid by the driver. This improves the accuracy of distracted driving determination.

### CITATION LIST

### Patent Literature

Patent Literature 1: Japanese Unexamined Patent Application Publication No. 6-251272

### SUMMARY

### Technical Problem

In addition to the technique described in Patent Literature 1, various other techniques may monitor the direction and the level of attention being paid by the driver.

The monitoring results of the direction and the level of attention being paid by the driver can also be used for other techniques such as a learning apparatus that learns driving habits and tendencies of the driver, in addition to the determination of distracted driving.

One or more aspects of the present invention are directed to a driver monitoring apparatus that monitors the direction and the level of attention being paid by a vehicle driver, a method for such monitoring, and a recording medium having a program for such monitoring recorded thereon.

### Solution to Problem

In response to the above issue, a driver monitoring apparatus according to a first aspect of the present invention includes a first sensor that outputs first sensing data including a monitoring image of a vehicle driver, a storage that stores the first sensing data output from the first sensor, a detector that detects an attention direction including a face or gaze direction of the driver based on the first sensing data in the storage, a calculator that repeatedly calculates, at every predetermined time, a deviation of the attention direction detected by the detector during a predetermined duration, and a driver attention determiner that determines a direction and a level of attention being paid by the driver based on the deviation calculated by the calculator.

The driver monitoring apparatus according to the first aspect detects the attention direction of the driver based on the first sensing data output from the first sensor, and repeatedly calculates, at every predetermined time, the deviation of the detected attention direction during the predetermined duration. The deviation decreases as the driver is paying attention for a longer period of time. The combined use of the deviation with the attention direction thus enables monitoring of both the direction and the level of attention being paid by the driver.

A driver monitoring apparatus according to a second aspect of the present invention is the apparatus according to the first aspect in which the driver attention determiner determines, as the level of attention, a degree of gaze of the driver in the attention direction.

The apparatus according to the second aspect determines the degree of gaze of the driver based on the deviation of the face or gaze direction of the driver. A smaller deviation indicates a higher degree of gaze. The driver gazing in one direction while driving the vehicle is likely to be intentional, or for example, gazing in one direction intentionally for safety checking. Thus, the attention level, or the degree of gaze of the driver, also indicates the likelihood that the driver is gazing intentionally.

A driver monitoring apparatus according to a third aspect of the present invention is the apparatus according to the first aspect in which the driver attention determiner determines, as the attention direction of the driver, an area including a position at which the driver is likely to be looking.

The apparatus according to the third aspect determines the area including a position at which the driver is likely to be looking based on the deviation of the face or gaze direction of the driver. The apparatus can thus reliably determine that the driver is not looking at an object.

A driver monitoring apparatus according to a fourth aspect of the present invention is the apparatus according to the first aspect in which the driver attention determiner determines the direction and the level of attention being paid by the driver based on a size and a position of a deviation area having the attention direction detected by the detector as a center and the deviation calculated by the calculator as a radius.

The apparatus according to the fourth aspect determines the direction and the level of attention being paid by the driver based on the size and the position of the deviation area having its center in the attention direction and its radius being the deviation. A smaller deviation area indicates a higher level of attention of the driver in the attention direction, or the driver gazing in the direction. A larger deviation area indicates a lower level of attention of the driver in the attention direction, or the driver vacantly looking in the direction.

A driver monitoring apparatus according to a fifth aspect of the present invention is the apparatus according to the any one of the first to fourth aspects in which the driver attention determiner determines whether the driver is looking at a position within a predetermined forward area defined in front of the vehicle based on the direction and the level of attention being paid by the driver.

The apparatus according to the fifth aspect determines whether the driver is looking at a position within a predetermined forward area based on the direction and the level of attention being paid by the driver. Thus, the apparatus according to the fourth aspect, which may be for example a distracted driving determination apparatus, can accurately determine distracted driving.

A driver monitoring apparatus according to a sixth aspect of the present invention is the apparatus according to the first aspect further including a second sensor that outputs second sensing data indicating a state of the vehicle. The storage further stores the second sensing data output from the second sensor. The detector further detects a speed of the vehicle based on the second sensing data in the storage. The apparatus according to the sixth aspect further includes a changer that changes a length of the predetermined duration in accordance with the vehicle speed detected by the detector.

The apparatus according to the sixth aspect changes the length of the predetermined duration for which the deviation is calculated in accordance with the vehicle speed. This enables calculation of the deviation for a duration defined appropriate for the vehicle speed.

A driver monitoring apparatus according to a seventh aspect of the present invention is the apparatus according to the first aspect further including a changer that changes a length of the predetermined duration in accordance with the attention direction detected by the detector.

The apparatus according to the seventh aspect changes the length of the predetermined duration for which the deviation is calculated in accordance with the attention direction. This enables calculation of the deviation for a duration defined appropriate for the direction of attention being paid by the driver.

A driver monitoring method according to an eighth aspect of the present invention is implemented by a driver monitoring apparatus for monitoring a vehicle driver. The method includes storing, with the driver monitoring apparatus, first sensing data including a monitoring image of a vehicle driver output from a first sensor into a storage, detecting, with the driver monitoring apparatus, an attention direction including a face or gaze direction of the driver based on the first sensing data in the storage, repeatedly calculating, at every predetermined time, with the driver monitoring apparatus, a deviation of the detected attention direction during a predetermined duration, and determining, with the driver monitoring apparatus, a direction and a level of attention being paid by the driver based on the calculated deviation.

With the method according to the eighth aspect, as with the apparatus according to the first aspect, the combined use of the deviation with the attention direction enables monitoring of both the direction and the level of attention being paid by the driver.

In response to the above issue, a non-transitory recording medium according to a ninth aspect of the present invention records a driver monitoring program causing a computer to function as the units included in the driver monitoring apparatus according to any one of the first to seventh aspects.

The non-transitory recording medium according to the ninth aspect uses the computer to implement the first to seventh aspects.

### Advantageous Effects

The driver monitoring apparatus, the driver monitoring method, and the recording medium having the driver monitoring program recoded thereon according to the aspects of the present invention enable monitoring of the direction and the level of attention being paid by a vehicle driver.

### BRIEF DESCRIPTION OF THE DRAWINGS

FIG. 1 is a block diagram showing an example use of a driver monitoring apparatus according to one embodiment of the present invention.

FIG. 2A is a schematic diagram describing the relationship between the deviation calculation time, the deviation calculation duration, the deviation, and the deviation area.

FIG. 2B is a schematic diagram describing the deviation area being narrower with a more focused gaze of the driver.

FIG. 3 is a block diagram of a driving state determination system including a driver monitoring apparatus according to one embodiment.

FIG. 4 is an example deviation calculation duration change table prestored in a monitoring result storage in the driving state determination system according to the embodiment.

FIG. 5 is a flowchart showing the procedure and processing performed by the driving state determination system according to the embodiment.

FIG. 6 is a schematic diagram describing an example state in which the driver is determined to be looking away from the front.

FIG. 7 is a schematic diagram describing another example state in which the driver is determined to be looking away from the front.

FIG. 8 is a schematic diagram describing still another example state in which the driver is determined to be looking away from the front.

FIG. 9 is a schematic diagram describing an example state in which the driver is not determined to be looking away from the front.

FIG. 10 is a schematic diagram describing another state in which the driver is not determined to be looking away from the front.

FIG. 11 is a schematic diagram describing still another example state in which the driver is not determined to be looking away from the front.

### DETAILED DESCRIPTION

Embodiments according to the present invention will be described below with reference to the drawings.

### Example Use

One example use of a driver monitoring apparatus that monitors a vehicle driver according to embodiments of the present invention will be described.

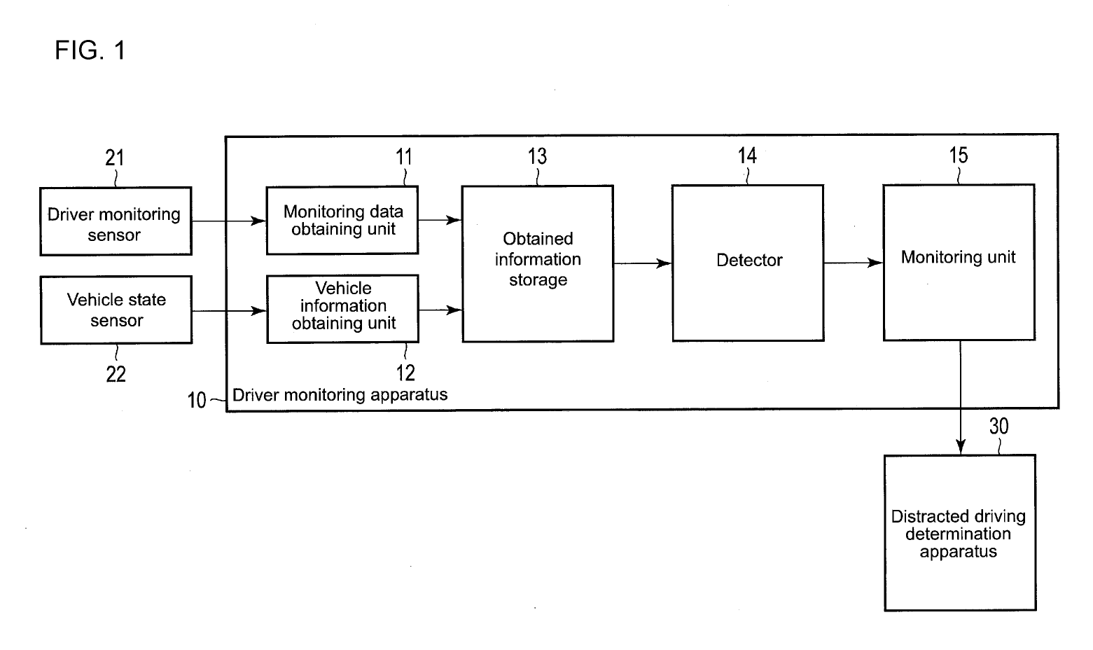

FIG. 1 is a block diagram of the driver monitoring apparatus in this example use. A driver monitoring apparatus 10 includes a monitoring data obtaining unit 11, a vehicle information obtaining unit 12, an obtained information storage 13, a detector 14, and a monitoring unit 15 that functions as a calculator, a driver attention determiner, a distracted driving determiner, and a changer.

The monitoring data obtaining unit 11 obtains driver monitoring data that is first sensing data including monitoring images of the driver from a driver monitoring sensor 21. The driver monitoring sensor 21 is installed at a predetermined position in a vehicle with respect to the driver and serves as a first sensor that captures a monitoring image of the driver. For example, the driver monitoring sensor 21 is installed at a location for capturing an image of the face of the driver. The driver monitoring sensor 21 may be a camera placed, for example, on the dashboard, at the center of the steering wheel, beside the speed meter, or on a front pillar to capture an image of the upper part of the driver body including the face. This camera may be a still camera that captures multiple still images of the driver per second or a video camera that captures moving images of the driver. The monitoring data obtaining unit 11 digitizes image signals from the camera and obtains the digitized image signals as the first sensing data including monitoring images of the driver. The monitoring data obtaining unit 11 stores the obtained first sensing data in the obtained information storage 13 as monitoring data.

The obtained information storage 13 includes, as storage media, a read-write nonvolatile memory such as a hard disk drive (HDD) or a solid state drive (SSD), and a volatile memory such as a random-access memory (RAM).

The vehicle information obtaining unit 12 obtains vehicle information from one or more vehicle state sensors 22 that each serve as a second sensor installed at a predetermined position of the vehicle. The vehicle state sensors 22 include a speed sensor for detecting the vehicle speed and a reverse gear sensor for detecting the selection of the reverse gear. As described above, the vehicle state sensors 22 may be one or more sensors. The vehicle information obtaining unit 12 digitizes the information detected by each vehicle state sensor 22 and obtains the digitized information as second sensing data indicating the vehicle state. Each vehicle state sensor 22 stores the obtained second sensing data into the obtained information storage 13 as vehicle information.

During operation of the engine and/or the motor serving as the vehicle power system, the detector 14 detects the attention direction of the driver, which is for example the face or gaze direction of the driver from the driver monitoring data stored in the obtained information storage 13.

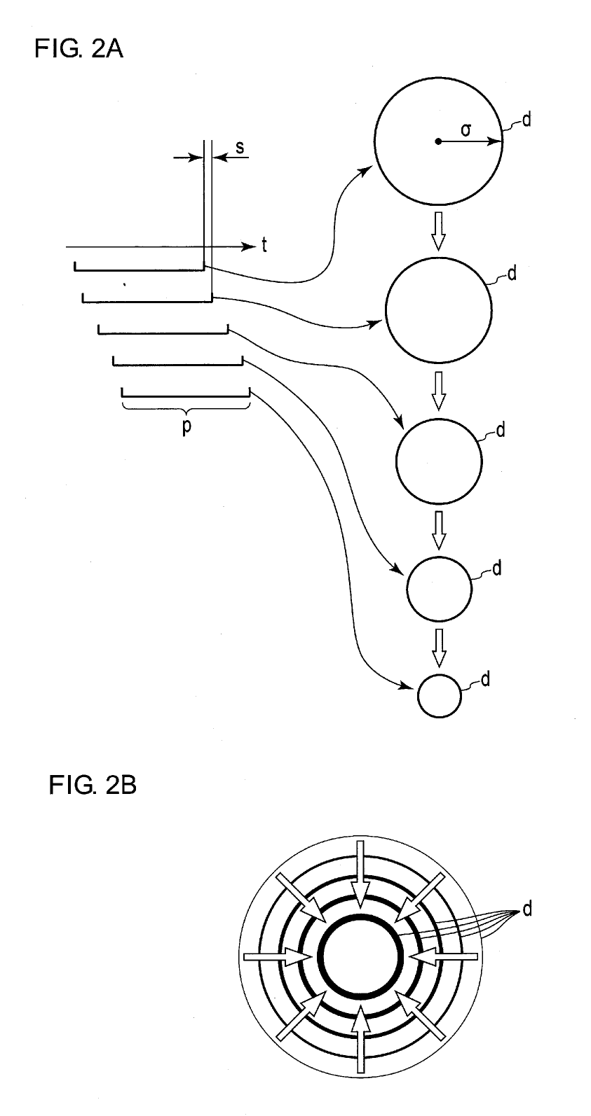

FIG. 2A is a schematic diagram describing the relationship between a deviation calculation time s, which serves as the predetermined time, a deviation calculation duration p, which serves as the predetermined duration, a deviation σ, and a deviation area d defined using the attention direction and the deviation σ. FIG. 2B is a schematic diagram describing the deviation area d being narrower with a more focused gaze of a driver. In FIG. 2B, thin to thick lines represent chronological changes. A thicker line indicates a newer deviation area d.

The monitoring unit 15 repeatedly calculates, at every deviation calculation time s, the deviation σ (e.g., standard deviation) of the attention direction detected by the detector 14 during the deviation calculation duration p. The monitoring unit 15 uses the calculated deviation σ to determine, for example, the level of attention to the direction in which the driver is gazing, or the degree of gaze of the driver. The degree of gaze of the driver indicates the likelihood that the driver is gazing intentionally.

The monitoring unit 15 also uses the calculated deviation σ to determine, as the direction in which the driver is gazing, a gaze-likely area in which the driver is likely to be looking. The determination result also reveals gaze-unlikely areas in which the driver is unlikely to be looking.

More specifically, the monitoring unit 15 determines the direction and the level of attention being paid by the driver in accordance with the deviation area d defined using the calculated deviation and the attention direction detected by the detector. The deviation area d herein is indicated by a circle having the attention direction as the center and the deviation σ as the radius.

The monitoring unit 15 uses the determined direction and level of attention being paid by the driver to determine whether the driver is looking at a position within a predetermined forward area defined in front of the vehicle.

The detector 14 further detects the vehicle speed based on the vehicle information stored in the obtained information storage 13. The monitoring unit 15 can change the length of the deviation calculation duration p in accordance with the vehicle speed. In some embodiments, the monitoring unit 15 may change the length of the deviation calculation duration p in accordance with the attention direction of the driver. In other embodiments, the monitoring unit 15 may change the length of the deviation calculation duration p in accordance with both the vehicle speed and the attention direction.

The monitoring result information, which is the determination result from the monitoring unit 15, is output, for example, to a distracted driving determination apparatus 30. The distracted driving determination apparatus 30 uses the monitoring result information to determine the state of the driver, for example, whether the driver is engaging in distracted driving.

The driver monitoring apparatus 10 with the configuration described above uses the detector 14 to detect the attention direction of the driver based on the monitoring data output from the driver monitoring sensor 21. The driver monitoring apparatus 10 also uses the monitoring unit 15 to repeatedly calculate, at every deviation calculation time s, the deviation σ (e.g., standard deviation) of the attention direction during the deviation calculation duration p. The deviation σ decreases as the driver is paying attention for a longer period of time. Thus, the deviation σ together with the attention direction enables monitoring of the direction and the level of attention being paid by the driver.

In the driver monitoring apparatus 10, the monitoring unit 15 also determines the degree of gaze of the driver based on the deviation σ of the face or gaze direction of the driver. As shown in FIG. 2A, the monitoring unit 15 calculates, at every deviation calculation time s serving as the predetermined time, the deviation σ of the attention direction during the deviation calculation duration p serving as the predetermined duration described above. The deviation σ decreases gradually as the driver is looking at or gazing at one object for a longer period of time. When the driver sees various objects one after another, the deviation σ may not decrease but may rather increase. Thus, a smaller deviation indicates a higher degree of gaze. The driver gazing in one direction while driving the vehicle is likely to be intentional, or for example, gazing in one direction intentionally for safety checking. Thus, the attention level, or the degree of gaze of the driver, also indicates the likelihood that the driver is gazing intentionally.

In the driver monitoring apparatus 10, the monitoring unit 15 determines an area including a position at which the driver is likely to be looking based on the deviation σ of the face or gaze direction of the driver. The monitoring unit 15 can thus determine an area in which the driver is likely to be looking, and also determine areas in which the driver is unlikely to be looking. More specifically, the monitoring unit 15 can reliably determine that the driver is not looking at an object.

In the driver monitoring apparatus 10, the monitoring unit 15 determines the direction and the level of attention being paid by the driver based on the size and the position of the deviation area d having the attention direction as the center and the deviation σ as the radius. The deviation area d decreases gradually as the driver is looking at one object for a longer period of time as shown in FIGS. 2A and 2B. When the driver sees various objects one after another, the deviation area d may not decrease but may rather increase. More specifically, a smaller deviation area d indicates a higher level of attention of the driver in the attention direction, or the driver gazing in the direction. A larger deviation area d indicates a lower level of attention of the driver in the attention direction, or the driver vacantly looking in the direction.

In this case, the monitoring unit 15 can determine whether the driver is looking at a position included in the predetermined forward area based on the direction and the level of attention being paid by the driver, and also on, for example, the deviation area d. When receiving the monitoring result information, which is the determination result, the distracted driving determination apparatus 30 can accurately determine distracted driving.

In the driver monitoring apparatus 10, the monitoring unit 15 can also change the length of the predetermined duration for which the deviation σ is calculated in accordance with the vehicle speed. This enables calculation of the deviation σ for a duration defined appropriate for the vehicle speed. A longer deviation calculation duration p causes the attention direction of the driver including the face or gaze direction to shift more, and thus the deviation σ to be greater. In addition, the period for which distracted driving is allowed is shorter as the vehicle is traveling faster. Thus, when the vehicle travels fast, the deviation calculation duration p may be shortened to enable faster determination based on the deviation σ.

In the driver monitoring apparatus 10, the monitoring unit 15 can also change the length of the predetermined duration for which the deviation σ is calculated in accordance with the attention direction. This enables calculation of the deviation σ for a duration defined appropriate for the direction of attention being paid by the driver. For example, the period for which the driver is allowed to have his or her eyes away from the forward direction varies depending on the angle of the attention direction with respect to the forward direction. Thus, when the attention direction of the driver forms at least a predetermined angle with the forward direction, the deviation calculation duration p may be shortened to enable faster determination based on the deviation σ.

### Embodiment

One embodiment of the invention will now be described.

### Configuration

### (1) System

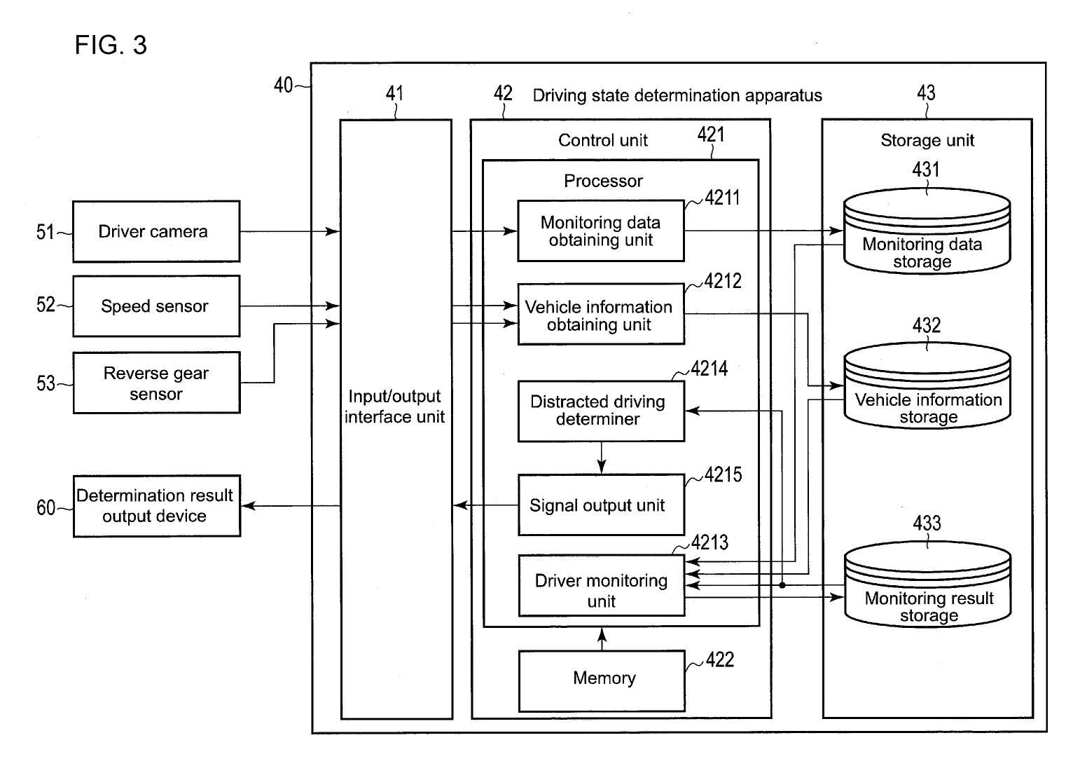

FIG. 3 is a schematic diagram describing a driving state determination system including a driver monitoring apparatus according to one embodiment of the present invention.

The driving state determination system includes a driving state determination apparatus 40 including a driver monitoring apparatus and a driving state determination apparatus according to this embodiment, various sensors 51 to 53, and a determination result output device 60.

### (2) Sensor

Sensors used in this embodiment include, for example, a driver camera 51 serving as a driver monitoring sensor, and a speed sensor 52 and a reverse gear sensor 53 serving as vehicle state sensors. These are mere examples, and other sensors, such as a steering sensor and a direction indicator sensor, may also be included.

The driver camera 51 is installed at a location for capturing an image of the face of the driver. The driver camera 51 is a camera placed, for example, on the dashboard, at the center of the steering wheel, beside the speed meter, or on a front pillar to capture an image of the upper part of the body of the driver including the face. The driver camera 51 may be a still camera that captures multiple still images per second or a video camera that captures moving images.

The speed sensor 52 detects the moving speed of the vehicle.

The reverse gear sensor 53 detects the selection of the reverse gear for reversing the vehicle.

### (3) Driving State Determination Apparatus

The driving state determination apparatus 40 includes an input-output interface unit 41, a control unit 42, and a storage unit 43.

The input-output interface unit 41 receives an image signal output from the driver camera 51, converts the received signal into digital data, and inputs the resulting data in the control unit 42. The input-output interface unit 41 also receives sensing data from each of the speed sensor 52 and the reverse gear sensor 53, and inputs the data in the control unit 42. The input-output interface unit 41 further converts driving state determination result information output from the control unit 42 into an output control signal and outputs the resulting signal to the determination result output device 60.

The storage unit 43 includes, as storage media, a read-write nonvolatile memory such as an SSD or an HDD and a volatile memory such as a RAM. The storage unit 43 includes, as storage areas used in the present embodiment, a monitoring data storage 431 for storing driver monitoring data, a vehicle information storage 432 for storing vehicle information indicating vehicle states, and a monitoring result storage 433 for storing monitoring result information in a volatile manner. The monitoring result information corresponds to determination results from a driver monitoring unit 4213 described later.

The monitoring result storage 433 may also prestore a deviation calculation duration change table in a nonvolatile manner. Although not shown, the monitoring result storage 433 may also be used as a buffer memory for the operation of the driver monitoring unit 4213. For example, the driver monitoring unit 4213 can store attention direction information indicating the detected attention direction in a volatile manner on a first-in, first-out (FIFO) basis. The FIFO buffer memory used herein has a predetermined capacity depending on the deviation calculation duration p. To use the deviation calculation duration change table, the FIFO buffer memory has a capacity for attention direction information corresponding to the longest deviation calculation duration in the table.

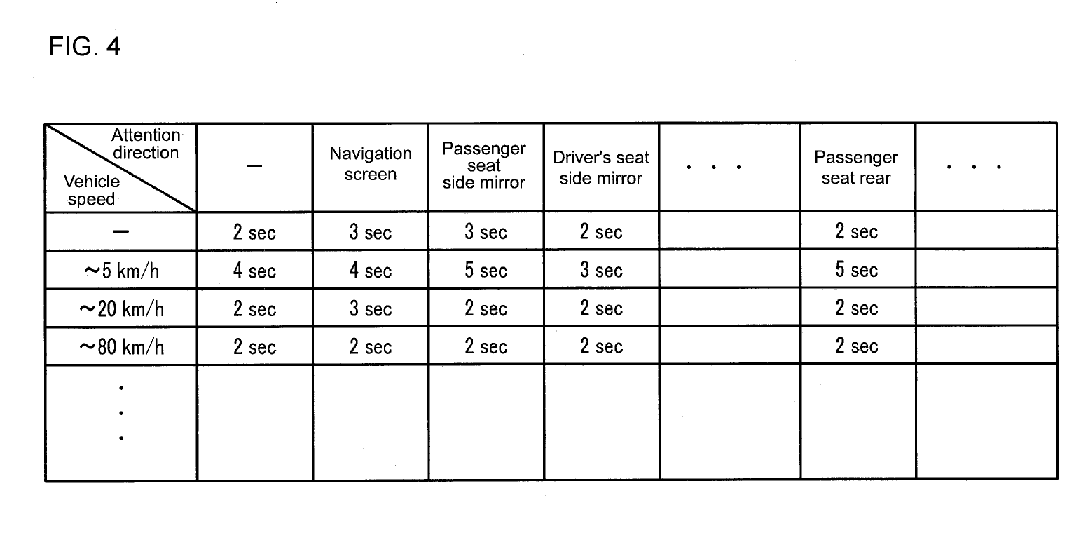

FIG. 4 is an example of the deviation calculation duration change table. The deviation calculation duration change table includes the deviation calculation duration p that is determined by the attention direction and the vehicle speed. The deviation calculation duration change table also stores the deviation calculation duration p that is simply determined by the attention direction or the vehicle speed. The durations stored in the example deviation calculation duration change table are mere examples, and other durations may also be included.

The control unit 42 includes a hardware processor 421 such as a central processing unit (CPU) and a program memory 422. The control unit 42 includes a monitoring data obtaining unit 4211, a vehicle information obtaining unit 4212, the driver monitoring unit 4213, a distracted driving determiner 4214 that is a distracted driving determination apparatus, and a signal output unit 4215 as software components for implementing the present embodiment. The software components are implemented by the hardware processor 421 executing a program stored in the program memory 422. Each of these software components may be dedicated hardware components.

The monitoring data obtaining unit 4211 obtains a monitoring image of the driver from the driver camera 51. More specifically, the monitoring data obtaining unit 4211 receives, through the input-output interface unit 41, digital data (image data) for a driver image signal output from the driver camera 51, and stores the received image data into the monitoring data storage 431 in the storage unit 43 as monitoring data.

The vehicle information obtaining unit 4212 obtains vehicle information from each of the speed sensor 52 and the reverse gear sensor 53. More specifically, the vehicle information obtaining unit 4212 receives, through the input-output interface unit 41, sensing data output from each of these sensors, and stores the received sensing data into the vehicle information storage 432 in the storage unit 43 as vehicle information.

During operation of the engine and/or the motor serving as the vehicle power system, the driver monitoring unit 4213 detects the attention direction of the driver including the face or gaze direction of the driver based on the driver monitoring data stored in the obtained information storage 13. The detected attention direction is stored as attention direction information into, for example, the FIFO buffer memory included in the monitoring result storage 433.

The driver monitoring unit 4213 reads the latest set of attention direction information during the deviation calculation duration p from the multiple sets of attention direction information stored in the FIFO buffer memory in the monitoring result storage 433, and calculates the deviation σ of the read sets of attention direction information. The deviation σ may be, for example, the standard deviation. The driver monitoring unit 4213 then temporarily stores the calculated deviation σ into the buffer memory included in the monitoring result storage 433. The driver monitoring unit 4213 repeatedly calculates the deviation σ at every deviation calculation time s.

The driver monitoring unit 4213 then determines the state of the driver, for example, whether the driver is looking in a forward area in accordance with the deviation area d defined using the latest attention direction information stored in the FIFO buffer memory in the monitoring result storage 433 and the deviation σ stored in the buffer memory in the monitoring result storage 433. The deviation area d herein is indicated by a circle having the attention direction as the center and the deviation σ as the radius. The driver monitoring unit 4213 temporarily stores the monitoring result information indicating the determination result into the buffer memory included in the monitoring result storage 433.

The driver monitoring unit 4213 may further detect the vehicle speed based on the vehicle information stored in the vehicle information storage 432. The driver monitoring unit 4213 may change the length of the deviation calculation duration p in accordance with the vehicle speed by referring to the deviation calculation duration change table in the monitoring result storage 433. In some embodiments, the driver monitoring unit 4213 may change the length of the deviation calculation duration p in accordance with the latest attention direction information stored in the FIFO buffer memory in the monitoring result storage 433 by referring to the deviation calculation duration change table in the monitoring result storage 433. In other embodiments, the driver monitoring unit 4213 may change the length of the deviation calculation duration p in accordance with both the vehicle speed and the attention direction information by referring to the deviation calculation duration change table in the monitoring result storage 433.

The monitoring result information, which is the determination result from the driver monitoring unit 4213, is output, for example, to the distracted driving determination apparatus 30. The distracted driving determination apparatus 30 uses the monitoring result information to determine the state of the driver, for example, whether the driver is engaging in distracted driving.

The hardware processor 421 including the driver monitoring unit 4213 starts operating when the vehicle power system is turned on, and stops operating when the vehicle power system is turned off.

The distracted driving determiner 4214 reads the monitoring result information from the monitoring result storage 433, and determines the state of the driver, for example, whether the driver is engaging in distracted driving based on the monitoring result information.

The signal output unit 4215 outputs the driving state determination result information indicating the state of the driving determined by the distracted driving determiner 4214 to the determination result output device 60 through the input-output interface unit 41.

### (4) Determination Result Output Device

The determination result output device 60 includes, for example, a speaker and an alert indicator lamp, and outputs the driving state determination result information output from the driving state determination apparatus 40 to the driver by emitting an alert sound or lighting the alert lamp. The determination result output device 60 may be one of the speaker and the alert indicator lamp. The determination result output device 60 may be implemented by a sound output function or an image display function of the navigation system included in the vehicle.

### Operation

The operation of the driving state determination system with the above configuration will now be described.

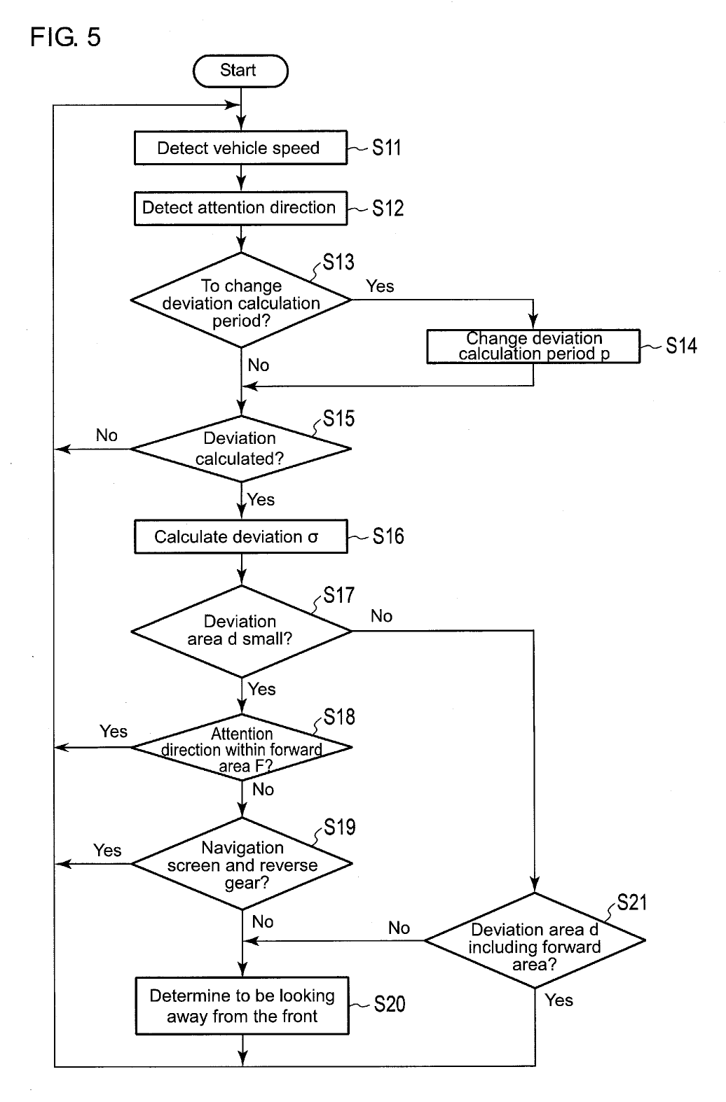

FIG. 5 is a flowchart showing the procedure and processing performed by the driving state determination system shown in FIG. 3.

### (1) Receiving Sensing Data

When the vehicle power system is turned on, the driving state determination apparatus 40, the driver camera 51 serving as a driver monitoring sensor, and the speed sensor 52 and the reverse gear sensor 53 serving as vehicle state sensors start operating. The driving state determination apparatus 40 uses the monitoring data obtaining unit 4211 to obtain sensing data from the driver camera 51 and store the sensing data into the monitoring data storage 431 as monitoring data. The driving state determination apparatus 40 also uses the vehicle information obtaining unit 4212 to obtain sensing data from each of the speed sensor 52 and the reverse gear sensor 53 and store the sensing data into the vehicle information storage 432 as vehicle information. Sensing data is repeatedly obtained and stored until the vehicle power system is turned off.

### (2) Calculating Monitoring Information

### (2-1) Detecting Vehicle Speed and Attention Direction

In parallel with the sensing data receiving operation, the driving state determination apparatus 40 uses the driver monitoring unit 4213 to detect the speed of the vehicle (vehicle speed) based on the vehicle information stored in the vehicle information storage 432 and store the detected speed into the buffer memory included in the monitoring result storage 433 by overwriting the existing speed in step S11. In the driving state determination apparatus 40, the driver monitoring unit 4213 detects the attention direction of the driver including the face or gaze direction of the driver based on the monitoring data stored in the monitoring data storage 431, and stores the attention direction information indicating the detected attention direction into the FIFO buffer memory included in the monitoring result storage 433 in step S12. For example, the monitoring data storage 431 may store 30 monitoring images as monitoring data obtained per second. In this case, the face or gaze direction of the driver is detected 30 times per second with respect to the forward direction (0°) used by the driving state determination apparatus, or a reference direction defined as the forward direction of the vehicle. The detected direction is stored into the FIFO buffer memory. The order of step S11 and step S12 may be reversed, or the two steps may be performed in parallel.

### (2-2) Changing Deviation Calculation Duration

In step S13, the driver monitoring unit 4213 in the driving state determination apparatus 40 determines whether the driving state determination apparatus 40 is predefined to change the length of the deviation calculation duration p. At the shipment from the factory or at the installation onto a vehicle, the driving state determination apparatus 40 may be predefined to change the length of the deviation calculation duration p depending on one or both the vehicle speed and the attention direction. This definition may be performed by the driver, or a user by, for example, operating an operation switch.

In step S14, the driver monitoring unit 4213 in the driving state determination apparatus 40, which has been determined to change the deviation calculation duration p, changes the length of the deviation calculation duration p in accordance with the vehicle speed and/or the attention direction by referring to the deviation calculation duration change table in the monitoring result storage 433.

### (2-3) Calculating Deviation

In step S15, the driver monitoring unit 4213 in the driving state determination apparatus 40 determines whether the time has reached the timing to calculate the deviation σ determined by the deviation calculation time s. Before the timing, the driver monitoring unit 4213 in the driving state determination apparatus 40 repeats the processing in step S11 and subsequent steps described above. In this manner, the vehicle speed and the attention direction are detected until the timing to calculate the deviation σ.

At the timing to calculate the deviation σ determined by the deviation calculation time s, the driver monitoring unit 4213 in the driving state determination apparatus 40 reads the latest set of attention direction information during the deviation calculation duration p from the multiple sets of attention direction information stored in the FIFO buffer memory in the monitoring result storage 433, and calculates the deviation σ in step S16. The deviation σ may be, for example, the standard deviation. For example, 30 attention direction information sets may be obtained per second as described above, and the deviation calculation duration p may be two seconds. In this case, the driver monitoring unit 4213 reads the 60 latest attention direction information sets from the FIFO buffer memory, and calculates the deviation σ of the 60 attention direction information sets. When the driver is gazing in one direction, the 60 attention direction information sets indicate substantially the same direction, and thus the deviation σ is small. In contrast, when the driver is not gazing in one direction, the 60 attention direction information sets vary to increase the deviation σ. The driver monitoring unit 4213 then stores the calculated deviation σ into the buffer memory included in the monitoring result storage 433 by overwriting the existing deviation σ.

### (2-4) Driver State Determination

When the deviation σ is calculated in this manner, the driving state determination apparatus 40 uses the driver monitoring unit 4213 to determine the state of the driver.

With known techniques, the states below may not be distinguished from one another based simply on the attention direction of the driver or for example the face or gaze direction of the driver when the angles are equal.

(1-A) The driver looks back for an instant check.

(1-B) The driver is distracted and looks out for some time.

(1-C) The driver is looking around, rather than forward.

Among them, states (1-B) and (1-C) correspond to distracted driving.

For particular areas on, for example, the screen of the navigation apparatus (navigation screen), the states below may not be distinguished from one another with known techniques.

(2-A) The driver looks across the navigation screen at the side mirror adjacent to the passenger seat.

(2-B) The driver looks at the navigation screen instantly to check the surrounding road conditions.

(2-C) The driver is driving while operating the navigation apparatus.

Among them, state (2-C) corresponds to distracted driving.

To allow the distracted driving determiner 4214 to reliably determine these distracted driving states, the driver monitoring unit 4213 in the driving state determination apparatus 40 performs the processing below.

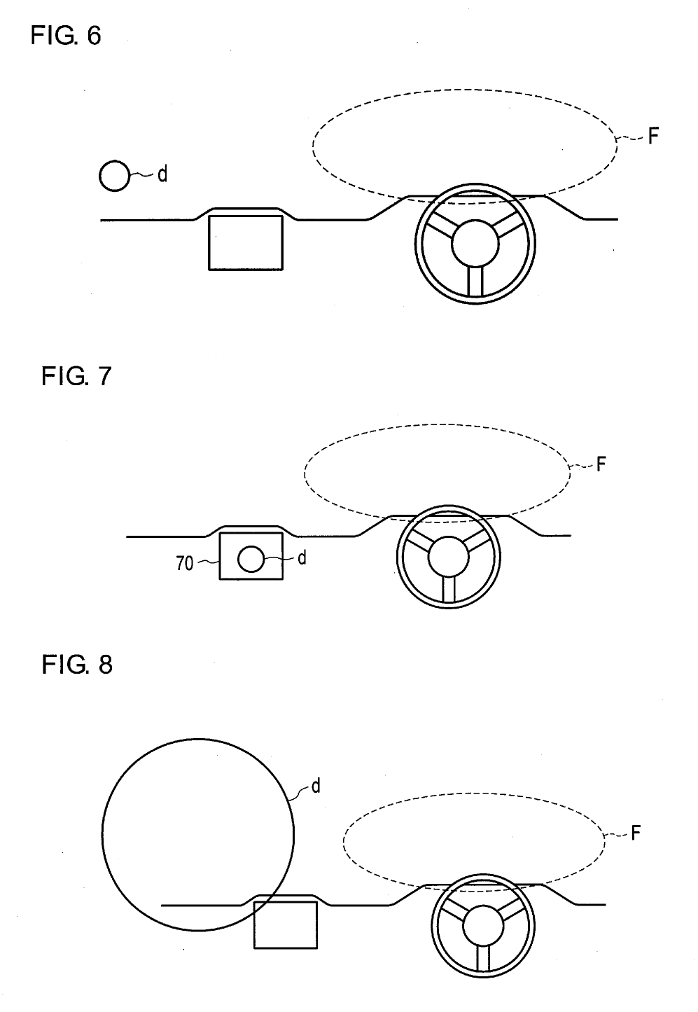

In step S17, the driver monitoring unit 4213 in the driving state determination apparatus 40 first reads the deviation σ and the latest attention direction information during the deviation calculation duration p from the FIFO buffer memory included in the monitoring result storage 433. The driver monitoring unit 4213 then determines whether the size (area size) of the deviation area d defined using the attention direction indicated by the attention direction information and the deviation σ is smaller than a predetermined threshold. When the size of the deviation area d is smaller than the threshold, the driver monitoring unit 4213 determines whether the attention direction is within a predetermined forward area F of the vehicle in step S18. As shown in FIG. 6, for example, the forward area F corresponds to an area in front of the driver's seat defined with respect to the forward direction (0°) used by the driving state determination apparatus, or the reference direction. For the forward area F, the distracted driving determiner 4214 detects no distracted driving even in the known determination based simply on the attention direction.

When the attention direction is within the forward area F, the driver is gazing in the forward direction of the vehicle. The driver monitoring unit 4213 in the driving state determination apparatus 40 thus repeats the processing in step S11 and subsequent steps described above. The driver monitoring unit 4213 in the driving state determination apparatus 40 may also store the monitoring result information indicating that the driver is looking in the forward direction into the buffer memory in the monitoring result storage 433 by overwriting the existing information.

In contrast, when the attention direction is out of the forward area F, the driver monitoring unit 4213 in the driving state determination apparatus 40 detects the selection state of the reverse gear based on the vehicle information stored in the vehicle information storage 432, and determines whether the attention is directed to the navigation screen and the reverse gear is selected in step S19. When the attention is directed to the navigation screen and the reverse gear is selected, the driver monitoring unit 4213 in the driving state determination apparatus 40 repeats the processing in step S11 and subsequent steps described above. The driver monitoring unit 4213 in the driving state determination apparatus 40 may also store the monitoring result information indicating the same determination result as when the driver is looking in the forward direction into the buffer memory in the monitoring result storage 433 by overwriting the existing information.

In contrast, when no attention is directed to the navigation screen and the reverse gear is unselected, the driver monitoring unit 4213 in the driving state determination apparatus 40 determines that the driver is looking away from the front, and stores the monitoring result information indicating that the driver is looking away from the front into the buffer memory in the monitoring result storage 433 by overwriting the existing information in step S20. The driver monitoring unit 4213 in the driving state determination apparatus 40 then repeats the processing in step S11 and subsequent steps described above.

When the size of the deviation area d is determined to be equal to or greater than the threshold in step S17, the driver monitoring unit 4213 in the driving state determination apparatus 40 determines whether the deviation area d includes the forward area F, and thus the deviation area d overlaps the forward area F in step S21. When the deviation area d is large but does not include the forward area F, the driver monitoring unit 4213 in the driving state determination apparatus 40 performs the processing in step S20 described above. More specifically, the driver monitoring unit 4213 obtains the determination result indicating that the driver is looking away from the front, and stores the monitoring result information indicating the obtained determination result into the buffer memory in the monitoring result storage 433 by overwriting the existing information.

In contrast, when the deviation area d is determined to include the forward area F in step S21, the driver monitoring unit 4213 in the driving state determination apparatus 40 repeats the processing in step S11 and subsequent steps described above. The driver monitoring unit 4213 in the driving state determination apparatus 40 may also store the monitoring result information indicating the same determination result as when the driver is looking in the forward direction into the buffer memory in the monitoring result storage 433 by overwriting the existing information.

FIGS. 6 to 11 are schematic diagrams describing the states determined by the driver monitoring unit 4213.

For example, in state (1-B) in which the driver is distracted and looks out for some time and in state (2-C) in which the driver is driving while operating the navigation apparatus, which both correspond to distracted driving, the deviation area d is determined to be smaller than the threshold in step S17 described above. The attention direction is thus determined to be out of the forward area F in step S18 described above. FIG. 6 shows state (1-B). FIG. 7 shows state (2-C). In state (1-B), the attention is determined not to be directed to a navigation screen 70 in step S19 described above, and the processing then advances to step S20 described above. In state (2-C), the attention is determined to be directed to the navigation screen 70. However, when the reverse gear is unselected, the processing also advances to step S20 described above. Thus, the driver is determined to be looking away from the front.

When the attention is directed to the navigation screen 70 and also the reverse gear is selected, the navigation screen 70 is likely to show an image from a rear view camera (not shown). Thus, when the attention is determined to be directed to the navigation screen and also the reverse gear is selected in step S19 described above, the processing does not advance to step S20 described above.

Thus, a small deviation σ or a small deviation area d indicates a high likelihood that the driver is firmly looking in the direction intentionally. For the distracted driving determiner 4214 to detect distracted driving when the direction is out of the forward area F, the monitoring result information indicating the determination result that the driver is looking away from the front is stored into the buffer memory in the monitoring result storage 433. However, the determination has exceptions to exclude undistracted driving states.

In state (1-C) in which the driver is looking around rather than forward, which corresponds to distracted driving, the size of the deviation area d is determined to be equal to or greater than the threshold in step S17 described above, and the deviation area d is determined to include no forward area F in step S21 described above. FIG. 8 shows this state. In this state, the processing advances from step S21 to step S20 described above, in which the driver is determined to be looking away from the front.

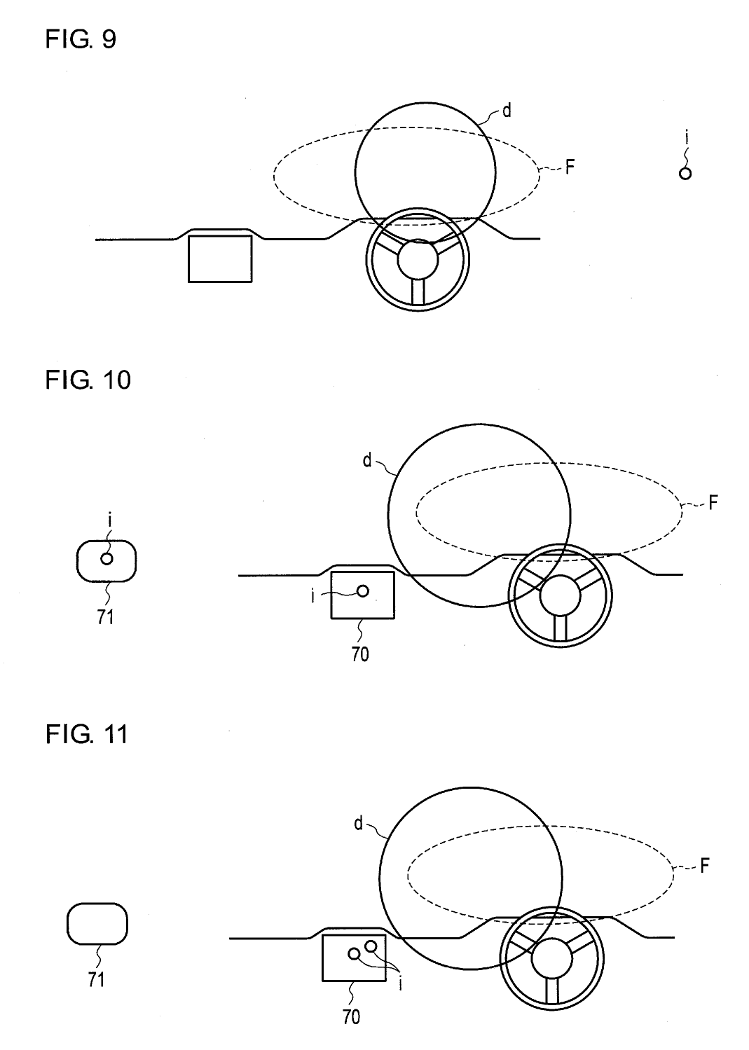

In state (1-A) in which the driver looks back for an instant check, which corresponds to undistracted driving, the size of the deviation area d is determined to be equal to or greater than the threshold in step S17 described above. However, the deviation area d is determined to include the forward area F in step S21 described above. FIG. 9 shows this state. The driver looking back instantly causes an instantaneously deviating direction i to occur as an attention direction, and increases the deviation σ, and thus the deviation area d. In this case, the instantaneously deviating direction i may have an angle corresponding to the level of distracted driving. However, this angle is instantaneous, and thus the deviation area d overlaps the forward area F. In this case, the determination in step S21 prevents the processing from advancing to step S20.

Similarly, in state (2-A) in which the driver looks across the navigation screen at the side mirror adjacent to the passenger seat, and state (2-B) in which the driver looks at the navigation screen instantly to check the surrounding road conditions, which both correspond to undistracted driving, the size of the deviation area d is determined to be equal to or greater than the threshold in step S17 described above. However, the deviation area d is determined to include the forward area F in step S21 described above. FIG. 10 shows state (2-A), in which the instantaneously deviating direction i occurs in the navigation screen 70 and the side mirror 71 adjacent to the passenger seat. FIG. 11 shows state (2-B), in which the instantaneously deviating direction i occurs in the navigation screen 70. Each state has the instantaneously deviating direction i, which increases the deviation σ, and thus the deviation area d. Also in this case, the determination in step S21 prevents the processing from advancing to step S20.

### (2-5) Driving State Determination

The distracted driving determiner 4214 in the driving state determination apparatus 40 also regularly reads the monitoring result information stored in the monitoring result storage 433, and determines whether the driver is engaging in distracted driving based on the read monitoring result information. The distracted driving determiner 4214 then uses the signal output unit 4215 to output the driving state determination result information indicating the result of the driving state determination to the determination result output device 60. Thus, the driving state determination result information is presented through the determination result output device 60 to the driver by emitting an alert sound or lighting the alert lamp.

### Advantages and Effects of Embodiment

In the embodiment described in detail above, the driving state determination apparatus 40 uses the driver monitoring unit 4213 to detect the attention direction of the driver based on the monitoring data transmitted from the driver camera 51 and stored in the monitoring data storage 431, and repeatedly calculates, at every deviation calculation time s, the deviation σ (e.g., standard deviation) of the attention direction during the deviation calculation duration p. The deviation σ decreases as the driver is paying attention for a longer period of time. Thus, the deviation σ together with the attention direction enables monitoring of the direction and the level of attention being paid by the driver.

In the driver monitoring apparatus 10, the driver monitoring unit 4213 can determine the degree of gaze of the driver based on the deviation σ of the face or gaze direction of the driver. The deviation σ decreases as the driver is looking at or gazing at one object for a longer period of time. When the driver sees various objects one after another, the deviation σ may not decrease but may rather increase. Thus, a smaller deviation indicates a higher degree of gaze. The driver gazing in one direction while driving the vehicle is likely to be intentional, or for example, gazing in one direction intentionally for safety checking. Thus, the attention level, or the degree of gaze of the driver, also indicates the likelihood that the driver is gazing intentionally.

In the driver monitoring apparatus 10, the driver monitoring unit 4213 determines an area including a position at which the driver is likely to be looking based on the deviation σ of the face or gaze direction of the driver. The driver monitoring unit 4213 can thus determine an area in which the driver is likely to be looking, and also areas in which the driver is unlikely to be looking. More specifically, the driver monitoring unit 4213 can reliably determine that the driver is not looking at an object.

In the driver monitoring apparatus 10, the driver monitoring unit 4213 determines the direction and the level of attention being paid by the driver based on the size and the position of the deviation area d having the attention direction as the center and the deviation σ as the radius. The deviation area d decreases as the driver is looking at one object for a longer period of time as shown in FIGS. 6 and 7. When the driver sees various objects one after another, the deviation area d may not decrease but rather increase as shown in FIG. 8. More specifically, a smaller deviation area d indicates a higher level of attention of the driver in the attention direction, or the driver gazing in the direction. A larger deviation area d indicates a lower level of attention of the driver in the attention direction, or the driver vacantly looking in the direction.

In this case, the driver monitoring unit 4213 can determine whether the driver is looking at a position included in the predetermined forward area F based on the direction and the level of attention being paid by the driver, and also on, for example, the deviation area d. When the deviation area d is large, the apparatus can determine whether the driver is intentionally in the same state instantly as for distracted driving as shown in FIGS. 9 to 11. Thus, the distracted driving determiner 4214 using the monitoring result information, which is the determination result, can accurately determine distracted driving.

In the driver monitoring apparatus 10, the driver monitoring unit 4213 can also change the length of the predetermined duration for which the deviation σ is calculated in accordance with the vehicle information transmitted from the speed sensor 52 and stored in the vehicle information storage 432. This enables calculation of the deviation σ for a duration defined appropriate for the vehicle speed. A longer deviation calculation duration p causes the attention direction of the driver including the face or gaze direction to shift more, and thus the deviation σ to be greater. In addition, the period for which distracted driving is allowed is shorter as the vehicle is traveling faster. Thus, when the vehicle travels fast, the deviation calculation duration p may be shortened to enable faster determination based on the deviation σ.

In the driver monitoring apparatus 10, the driver monitoring unit 4213 can also change the length of the predetermined duration for which the deviation σ is calculated in accordance with the detected attention direction. This enables calculation of the deviation σ for a duration defined appropriate for the direction of attention being paid by the driver. For example, the period for which the driver is allowed to have his or her eyes away from the forward direction varies depending on the angle of the attention direction with respect to the forward direction. Thus, when the attention direction of the driver forms at least a predetermined angle with the forward direction, the deviation calculation duration p may be shortened to enable faster determination based on the deviation σ.

### Modifications

The embodiments of the present invention described in detail above are mere examples of the present invention in all respects. The embodiment may be variously modified or altered without departing from the scope of the present invention. More specifically, the present invention may be implemented as appropriate using the configuration specific to each embodiment.

(1) Although the above embodiment uses the deviation calculation duration p that is changeable, the deviation calculation duration may be a predetermined fixed value. In this case, the processing in steps S13 and S14 is eliminated.

(2) The apparatus according to the above embodiment performs the determination in step S19 to prevent the driver's gaze on the navigation screen 70 from being determined as distracted driving when the vehicle is being reversed. Similarly, for example, the direction indicator sensor included in the vehicle state sensors 22 may detect a direction indicator operation, and the apparatus may perform the determination for the operation. When the driver is intentionally gazing on a side mirror or looking back for a safety check in turning right or left or changing lanes, the determination can prevent such gazing or looking from being determined as distracted driving. Likewise, other vehicle state sensors 22 may be used to have various exceptions.

(3) The vehicle speed and the attention direction of the driver are repeatedly detected a few to tens of times per second. Thus, the driver monitoring unit 4213 may be limited by the performance of the hardware processor 421 and may not complete the processing in steps S16 to S21 described above within the single detection duration. In this case, the processing in steps S11 to S21 may not be performed in series, but may be divided into the processing in steps S11 to S14 and the processing in steps S15 to S21, which may be performed in parallel.

(4) In the above embodiment, the distracted driving determiner 4214 uses the monitoring result information stored in the monitoring result storage 433. However, for example, other techniques such as a learning unit that learns driving habits and tendencies of the driver may use the monitoring result information.

The present invention is not limited to the embodiments described above, but the components may be modified without departing from the spirit and scope of the invention. The components described in the above embodiments may be combined as appropriate to provide various aspects of the invention. For example, some of the components described in each embodiment described above may be eliminated. Further, components in different embodiments may be combined as appropriate.

### Appendixes

The embodiments described above may be partially or entirely expressed in, but not limited to, the following forms shown in the appendixes below.

### Appendix 1

A driver monitoring apparatus (10;40), comprising:

a first sensor (21; 51) configured to output first sensing data including a monitoring image of a vehicle driver;

a storage (13; 431) configured to store the first sensing data output from the first sensor;

a detector (14; 4213) configured to detect an attention direction including a face or gaze direction of the driver based on the first sensing data in the storage;

a calculator (15; 4213) configured to repeatedly calculate, at every predetermined time, a deviation of the attention direction detected by the detector during a predetermined duration; and

a determiner (15; 4213) configured to determine a direction and a level of attention being paid by the driver based on the deviation calculated by the calculator.

### Appendix 2

A driver monitoring method implemented by a driver monitoring apparatus (10; 40) for monitoring a vehicle driver, the method comprising:

storing, with the driver monitoring apparatus, first sensing data into a storage (13; 431), the first sensing data including a monitoring image of the vehicle driver output from a first sensor (21;51);

detecting, with the driver monitoring apparatus, an attention direction including a face or gaze direction of the driver based on the first sensing data in the storage;

repeatedly calculating, at every predetermined time, with the driver monitoring apparatus, a deviation of the detected attention direction during a predetermined duration; and

determining, with the driver monitoring apparatus, a direction and a level of attention being paid by the driver based on the calculated deviation.

### Appendix 3

A driver monitoring apparatus (40) including a hardware processor (421) and a memory (431), the hardware processor being configured to

store first sensing data into the memory, the first sensing data including a monitoring image of a vehicle driver output from a first sensor (51);

detect an attention direction including a face or gaze direction of the driver based on the first sensing data in the memory;

repeatedly calculate, at every predetermined time, a deviation of the detected attention direction during a predetermined duration; and

determine a direction and a level of attention being paid by the driver based on the calculated deviation.

### Appendix 4

A driver monitoring method implemented by an apparatus including a hardware processor (421) and a memory (431), the method comprising:

storing, with the hardware processor, first sensing data into the memory, the first sensing data including a monitoring image of a vehicle driver output from a first sensor (51);

detecting, with the hardware processor, an attention direction including a face or gaze direction of the driver based on the first sensing data in the memory;

repeatedly calculating, at every predetermined time, with the hardware processor, a deviation of the detected attention direction during a predetermined duration; and

determining, with the hardware processor, a direction and a level of attention being paid by the driver based on the calculated deviation.

1. A driver monitoring apparatus, comprising:
a first sensor configured to output first sensing data including a monitoring image of a vehicle driver;
a storage configured to store the first sensing data output from the first sensor;
a detector configured to detect an attention direction including a face or gaze direction of the driver based on the first sensing data stored in the storage;
a calculator configured to repeatedly calculate, at every predetermined time, a deviation of the attention direction detected by the detector during a predetermined duration; and
a determiner configured to determine a direction and a level of attention being paid by the driver based on the deviation calculated by the calculator.

2. The driver monitoring apparatus according to claim 1, wherein
the determiner determines, as the level of attention, a degree of gaze of the driver in the attention direction.

3. The driver monitoring apparatus according to claim 2, wherein
the determiner determines whether the driver is looking at a position within a predetermined forward area defined in front of the vehicle based on the direction and the level of attention being paid by the driver.

4. The driver monitoring apparatus according to claim 1, wherein
the determiner determines, as the attention direction of the driver, an area including a position at which the driver is likely to be looking.

5. The driver monitoring apparatus according to claim 4, wherein
the determiner determines whether the driver is looking at a position within a predetermined forward area defined in front of the vehicle based on the direction and the level of attention being paid by the driver.

6. The driver monitoring apparatus according to claim 1, wherein
the determiner determines the direction and the level of attention being paid by the driver based on a size and a position of a deviation area having the attention direction detected by the detector as a center and the deviation calculated by the calculator as a radius.

7. The driver monitoring apparatus according to claim 6, wherein
the determiner determines whether the driver is looking at a position within a predetermined forward area defined in front of the vehicle based on the direction and the level of attention being paid by the driver.

8. The driver monitoring apparatus according to claim 1, wherein
the determiner determines whether the driver is looking at a position within a predetermined forward area defined in front of the vehicle based on the direction and the level of attention being paid by the driver.

9. The driver monitoring apparatus according to claim 1, further comprising:
a second sensor configured to output second sensing data indicating a state of the vehicle,
wherein the storage further stores the second sensing data output from the second sensor,
the detector further detects a speed of the vehicle based on the second sensing data stored in the storage, and
the apparatus further comprises a changer configured to change a length of the predetermined duration in accordance with the vehicle speed detected by the detector.

10. The driver monitoring apparatus according to claim 1, further comprising:
a changer configured to change a length of the predetermined duration in accordance with the attention direction detected by the detector.

11. A driver monitoring method implemented by a driver monitoring apparatus for monitoring a vehicle driver, the method comprising:
storing, with the driver monitoring apparatus, first sensing data into a storage, the first sensing data including a monitoring image of the vehicle driver output from a first sensor;
detecting, with the driver monitoring apparatus, an attention direction including a face or gaze direction of the driver based on the first sensing data stored in the storage;
repeatedly calculating, at every predetermined time, with the driver monitoring apparatus, a deviation of the detected attention direction during a predetermined duration; and
determining, with the driver monitoring apparatus, a direction and a level of attention being paid by the driver based on the calculated deviation.

12. A non-transitory recording medium having a driver monitoring program recorded thereon causing a computer to function as the units included in the driver monitoring apparatus according to claim 1.
